(19) United States
(12) Patent Application Publication
(10) Pub. No.: US 2009/0196803 A1
(43) Pub. Date: Aug. 6, 2009

(54) WASTE LIQUID TREATING DEVICE

(75) Inventor: Toshio KUMAGAI, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/364,101

(22) Filed: Feb. 2, 2009

(30) Foreign Application Priority Data
Feb. 4, 2008 (JP) 2008-023576

(51) Int. Cl. C02F 1/48

(52) U.S. Cl. 422/186.3

(57) ABSTRACT

There is provided a waste liquid treating device including a drum like waste liquid tank that can be rotated in which liquid that is cured by irradiation of energy ray is introduced as waste liquid, a rotation driving unit for rotating the drum like waste liquid tank about a rotation axis of the drum like waste liquid tank, and an irradiation unit for irradiating energy ray for curing waste liquid in the drum like waste liquid tank that is rotated by the rotation driving unit.

### CROSS-REFERENCE TO RELATED APPLICATIONS

This application claims priority under the Paris Convention based on Japanese Patent Application No. 2008-23576 (filed on Feb. 4, 2008).

### BACKGROUND

1. Technical Field

The present invention relates to a waste liquid treating device of energy ray curing type liquid such as energy ray curing type ink that is cured by irradiation of energy ray such as ultraviolet (UV), and in particular, to a waste liquid treating device that can be applied to a liquid ejecting apparatus such as an ink jet type recording apparatus for ejecting an ink drop from a nozzle in accordance with print data to form a dot on a recording medium.

2. Related Art

In a liquid ejecting apparatus for ejecting liquid on a target, an ink jet type recording apparatus for ejecting ink on a recording paper for printing has been known. In a recording head of the ink jet type recording apparatus, ink that is pressurized in a pressure chamber is ejected on a recording paper as an ink drop from a nozzle for printing. Accordingly, there is a problem in that print error occurs because of defective ejection due to, for example, increase of ink viscosity caused by evaporation of a solvent from a nozzle opening, solidification of ink, attachment of dust, or mixture of bubbles.

Accordingly, capping means for sealing the nozzle opening of the recording head when printing is not performed and a wiping member for cleaning a nozzle forming surface as necessary are equipped in the ink jet type recording apparatus. The capping means not only functions as a cap for preventing drying of the ink in the nozzle opening, but also functions to eliminate clogging of the nozzle opening by sealing the nozzle surface by the capping means and by suctioning and discharging ink from the nozzle opening by applying a negative pressure from a suction pump when clogging or the like occurs in the nozzle opening.

A suction discharge treating of ink forcibly performed for eliminating clogging of the recording head is called as a cleaning operation, and is performed, for example, when restarting printing by the recording apparatus after being left for a long time, or when a user recognizes an error of a printing state and operates a cleaning switch. The cleaning operation includes an operation for wiping the nozzle forming surface of the recording head is performed by a wiping member made of an elastic plate such as rubber after ink is discharged from the recording head.

Then, the waste liquid discharged from the recording head and stored in the capping means by the cleaning operation can be discarded in a waste liquid tank by driving a suction pump. Further, a waste liquid suction member generally constituted by a spongy material is stored in the waste liquid tank, and the waste liquid is suctioned and retained in the waste liquid suction member.

On the other hand, as a type of an ink jet recording method, there is an UV ink jet method. The UV ink jet method is a recording method in which energy ray curing ink that is cured by irradiation of energy ray such as ultraviolet (UV) is adhered on a recording medium and the energy ray curing ink is cured to perform printing by irradiating energy ray on the recording medium.

In such a recording apparatus of the UV ink jet type, it is proposed that the waste ink that is sucked by the cleaning operation is introduced in a waste ink tray that is a waste liquid vessel, and ultraviolet is irradiated with respect to the waste liquid introduced in the waste liquid vessel for curing (see JP-A-2003-211705 (hereinafter, referred to as Patent Document 1)).

However, in the apparatus of Patent Document 1, the cured waste liquid is not transparent, and ultraviolet is irradiated with respect to the liquid surface from the upper side of the waste liquid vessel in which the waste liquid is introduced. Although the ultraviolet ray is easily passed through a part near the liquid surface and the part is speedy cured, as becomes close to the bottom, the ultraviolet ray becomes hard to reach. Accordingly, there remains an uncured portion in the waste liquid. The tendency is remarkable in the ink whose color is dark, especially in black or the like.

Liquid of an ultraviolet curing type generally includes a material having skin stimulus property and has a strong irritating smell, and if the liquid is in an uncured state, there is a possibility to affect a negative influence to a human body when the liquid directly touches skin, and also provides bad working conditions due to the irritating smell. On the other hand, it is know that once the liquid is cured by ultraviolet, it becomes harmlessness and the irritating smell is restrained. With the circumstances, as in the apparatus of Patent Document 1, when the waste liquid of the ultraviolet curing type is remained in an uncured state, there is a problem in that safeness and comfort of working conditions can not be assured when, for example, the waste liquid vessel is recovered and thermal disposal is performed.

### SUMMARY

An advantage of some aspects of the invention is to provide a waste liquid treating device which makes it possible to perform a waste liquid treatment with safety and ease by surely solidifying liquid so as to be harmless for recovering.

According to an aspect of the invention, there is provided a waste liquid treating device including a drum like waste liquid tank that can be rotated in which liquid that is cured by irradiation of energy ray is introduced as waste liquid, a rotation driving unit for rotating the drum like waste liquid tank about a rotation axis of the drum like waste liquid tank, and an irradiation unit for irradiating energy ray for curing waste liquid in the drum like waste liquid tank that is rotated by the rotation driving unit.

In the waste liquid treating device according to the aspect of the invention, since energy ray for curing waste liquid is irradiated in the drum like waste liquid tank that is rotated about the rotation axis of the drum like waste liquid tank, uncured waste liquid stored at the bottom of the dram like waste liquid tank is cured while sequentially adhering on the inner peripheral surface by irradiation of the energy ray. In this manner, the waste liquid is cured while sequentially adhering on the inner peripheral surface of the drum like waste liquid tank. Accordingly, by continuing rotation of the drum like waste liquid tank and irradiation of energy ray for curing in the drum like waste liquid tank, all of the uncured waste liquid stored at the bottom of the drum like waste liquid tank is adhered on the inner peripheral surface of the drum like waste liquid tank before long and cured. By repeating the operations, all of the waste liquid in the drum like waste liquid tank is cured and there remains no uncured portion. Accordingly, safeness and comfort of operations in the recovering/treating of the drum like waste liquid tank can be assured.

It is preferable that an angle of a shaft center of the drum like waste liquid tank is set to level or level to 60 degrees in the aspect of the invention. In this case, if the shaft center is about level, when the waste liquid is introduced in the drum like waste liquid tank, the uncured waste liquid stored at the bottom is spread, and the waste liquid is effectively cured while adhering on the inner peripheral surface by the rotation of the drum like waste liquid tank and the irradiation of energy ray. Consequently, all of the waste liquid in the drum like waste liquid tank is cured and there remains no uncured portion. Accordingly, safeness and comfort of operations in the recovering/treating of the drum like waste liquid tank can be assured. On the other hand, when the shaft center becomes about 60 degrees, the correction amount of the waste liquid in the drum like waste liquid tank can be increased.

It is preferable that the irradiation unit is constituted to irradiate an inner peripheral surface of the drum like waste liquid tank that is wetted due to stored waste liquid adhered in a film manner when the drum like waste liquid tank is rotated in the aspect of the invention. In this case, by the rotation of the drum like waste liquid tank and the irradiation of energy ray, the waste liquid wetted in a thin film state on the inner peripheral surface of the drum like waste liquid tank is effectively cured while adhering on the inner peripheral surface. Accordingly, the introduced waste liquid can be cured for a short period, and all of the waste liquid in the drum like waste liquid tank can be cured and there remains no uncured portion. Accordingly, safeness and comfort of operations in the recovering/treating of the drum like waste liquid tank can be assured.

It is preferable to further include a support drum that is rotated for supporting a recording medium on a support surface, an ejection head for ejecting energy ray curing type liquid from a nozzle toward the recording medium supported on the support surface, and an irradiation section for irradiating energy ray with respect to the energy ray curing type liquid ejected from the ejection head and adhered on the recording medium, and that the support drum also serves as the drum like waste liquid tank in the aspect of the invention. In this case, the support drum also serves as the drum like waste liquid tank in a liquid ejecting apparatus of a type that supports the recording medium on the support drum and ejects energy ray curing type liquid. Herewith, the space for storing waste liquid can be substantially reduced, and this is advantageous for downsizing the apparatus.

### BRIEF DESCRIPTION OF THE DRAWINGS

The invention will be described with reference to the accompanying drawings, wherein like numbers reference like elements.

FIG. 1 is a diagram schematically showing a structure of a recording apparatus to which the invention is applied.

FIGS. 2A, 2B are cross sectional views showing a structure of a waste liquid treating device of the invention.

FIGS. 3A, 3B are diagrams illustrating a modification of the waste liquid treating device.

FIG. 4 is a diagram illustrating a modification of the waste liquid treating device.

FIG. 5 is a diagram showing a second embodiment.

FIGS. 6A, 6B are diagrams showing a third embodiment.

### DESCRIPTION OF EXEMPLARY EMBODIMENTS

Next, embodiments of the invention will be described in detail.

Hereinafter, an embodiment in which a waste liquid treating device of the invention is applied to an ink jet type recording apparatus as a liquid ejecting apparatus will be described with reference to the accompanying drawings.

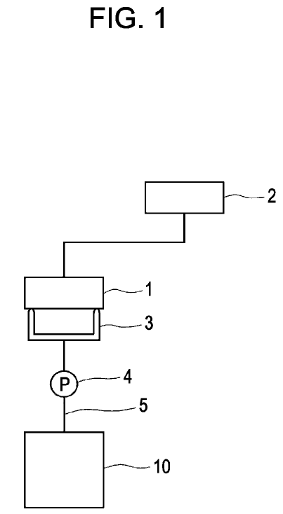

FIG. 1 is a diagram showing a structure of a main portion of an ink jet type recording apparatus as a liquid ejecting apparatus to which the invention is applied.

In FIG. 1, reference numeral 1 denotes an ejection head 1 for ejecting an ink drop from a nozzle with respect to a target not shown for recording, ink being supplied to the ejection head 1 from an ink cartridge 2 as an ink tank. Reference numeral 3 denotes capping means 3 disposed outside a recording area. A suction pump 4 for applying a negative pressure to an inner space of the capping means 3 is connected to the capping means 3.

The capping means 3 functions as a cap body for sealing a nozzle forming surface of the ejection head 1 to prevent drying of the nozzle during stopping of the recording apparatus. The capping means 3 also functions as cleaning means for absorbing and discharging ink from the ejection head 1 by applying a negative pressure to the ejection head 1 by the suction pump 4.

With the structure, for example, when the ink cartridge 2 is exchanged, when clogging is occurred in the nozzle of the ejection head 1, when starting after being left for a long time, ink is forcibly absorbed and discharged by capping the nozzle forming surface of the ejection head 1 with the capping means 3 and by performing suction with the suction pump 4. In this manner, ink whose viscosity is increased and bubbles in the ejection head 1 are suctioned and discharged to be able to maintain ejection property of the ejection head 1.

The ink discharged from an ink discharge path 5 by suction by the suction pump 4 is introduced in a waste liquid treating device 10 of the invention, and a hardening treatment is performed in the waste liquid treating device 10.

In the embodiment, energy ray curing type liquid such as energy ray curing type ink that is cured by irradiation of energy ray represented by light such as ultraviolet (UV) is used as the ink. For example, ultraviolet curing ink is used. Specifically, the ink is constituted by components of, for example, an ultraviolet curing resin (5 to 10%), a pigment (5 to 10%), an additive (about 20%) for providing stable printing in ink jet, water (60 to 70%), and the like.

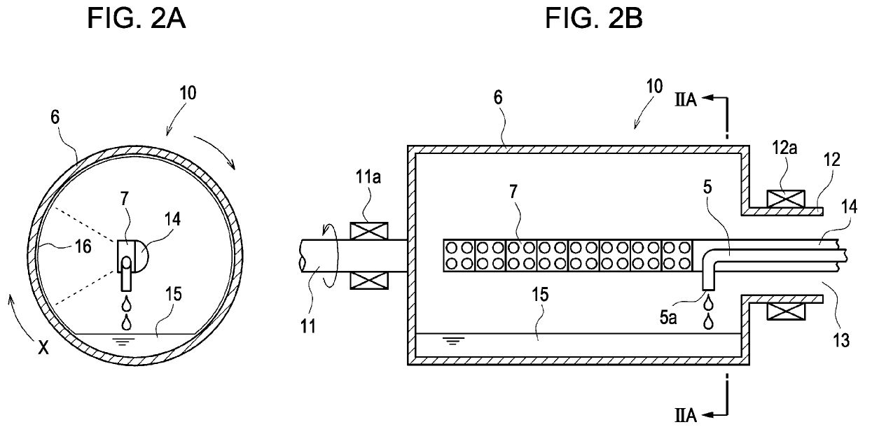

FIGS. 2A, 2B are diagrams showing a structure of the waste liquid treating device 10. FIG. 2A is a cross sectional view taken along the line IIA-IIA of FIG. 2B, and FIG. 2B is a cross sectional view of the waste liquid treating device 10 in a longitudinal direction.

The waste liquid treating device 10 is equipped with a drum like waste liquid tank that can be rotated in which liquid that is cured by irradiation of energy ray is introduced as waste liquid, rotation driving means (not shown) for rotating the drum like waste tank about a rotation axis 11 of the drum like waste tank, and irradiation means 7 for irradiating energy ray for curing waste liquid in the drum like waste liquid tank 6 that is rotated by the rotation driving means.

To be more specific, the drum like waste liquid tank 6 has a cylindrical shape as a whole in which one end is closed and an opening 13 is provided at the other end. The rotation axis 11 coupled with the rotation driving means not shown is provided at the closed end of the d drum like waste liquid tank 6, and an opening nozzle 12 is projectively formed at the other end. The rotation axis 11 and the opening nozzle 12 are formed so as to have the same axis as that of the drum like waste liquid tank 6, and the rotation axis 11 and the opening nozzle 12 are respectively pivotally supported by shaft bearings 11a, 12a. Herewith, when the rotation axis 11 is rotated by the rotation driving means, the drum like waste liquid tank 6 is rotated so that the peripheral wall is rotated in the circumference direction. In the embodiment, the rotation axis 11, that is, the shaft center of the drum like waste liquid tank 6 is set to approximately level.

Further, the irradiation means 7 is inserted in the drum like waste liquid tank 6 from the opening 13. The irradiation means 7 irradiates ultraviolet (UV light) as energy ray, and specifically, for example, an LED or the like that emits light in the ultraviolet band can be used.

The irradiation means 7 is attached to an arm 14 attached at a motionlessness portion of the ink jet type recording apparatus, and is provided so as to irradiate energy ray with respect to the inner peripheral surface of the drum like waste liquid tank 6. That is, the irradiation means 7 is constituted to irradiate the inner peripheral surface of the drum like waste liquid tank 6 that is wetted due to stored waste liquid 15 adhered in a film manner when the drum like waste liquid tank 6 is rotated. In the embodiment, the irradiation means 7 irradiates energy ray within an angle of about 90 degrees on the inner peripheral surface at the down stream side of the rotation direction (shown by the arrow X in FIG. 2A) than the waste liquid 15 stored at the bottom of the drum like waste liquid tank 6.

Further, the irradiation means 7 is disposed along the longitudinal direction of the drum like waste liquid tank 6, and irradiates energy ray across the whole length of the inner peripheral surface of the drum like waste liquid tank 6 in the longitudinal direction. Further, an ink discharge path 5 that is connected to the suction pump 4 and that discharges waste liquid in the capping means 3 is attached along a root of the arm 14. The ink discharge path 5 is inserted from the opening 13 and introduces waste liquid into the drum like waste liquid tank 6 from a distal opening 5a. The irradiation means 7 and the ink discharge path 5 are disposed at the vicinity of the shaft center of the drum like waste liquid tank 6 in a diameter direction of the drum like waste liquid tank 6.

The arm 14 is constituted so as to be moved forward and backward toward the opening 13 of the drum like waste liquid tank 6. When the irradiation means 7 and the distal opening 5a of the ink discharge path 5 are inserted in the drum like waste liquid tank 6, the arm 14 is held at a position that is moved forwardly toward an inner portion of the drum like waste liquid tank 6 (state shown in FIG. 2B). When detachment or exchanging of the drum like waste liquid tank 6 is performed, the arm 14 is moved backwardly from the opening 13 of the drum like waste liquid tank 6.

With the aforementioned structure, the waste liquid treating device 10 performs a treatment of waste liquid as described below.

That is, in the ink jet type recording apparatus, at a predetermined suction timing, for example, when the ink cartridge 2 is exchanged, when clogging is occurred in the nozzle of the ejection head 1, when starting after being left for a long time, the nozzle forming surface of the ejection head 1 is capped by the capping means 3 and sucked by the suction pump 4. Herewith, ink is forcibly sucked and discharged.

The sucked ink is introduced in the drum like waste liquid tank 6 from the distal opening 5a of the ink discharge path 5. Control means not shown controls the rotation driving means to starts rotation driving of the drum like waste liquid tank 6 at the timing when ink is sucked and waste liquid is introduced in the drum like waste liquid tank 6, and controls the irradiation means 7 to start irradiation of energy ray.

Then, the waste liquid 15 stored at the bottom of the drum like waste liquid tank 6 is coated and adhered on the inner peripheral surface with the rotation of the drum like waste liquid tank 6 as a thin liquid film 16 to be lifted. Then, energy ray is irradiated with respect to the liquid film 16 adhered on the inner peripheral surface of the drum like waste liquid tank 6 from the irradiation means 7, and the liquid film 16 is cured while being adhered on the inner peripheral surface. Then, by continuing rotation of the drum like waste liquid tank 6, a cured film formed by curing the liquid film 16 is eroded by the waste liquid 15 stored at the bottom, and a new liquid film 16 is adhered on the inner peripheral surface and is cured by the irradiation of the energy ray.

By repeating the operation, the cured film of the waste liquid is gradually laminated on the inner peripheral surface of the drum like waste liquid tank 6, and is recovered as cured waste liquid. By laminating the cured film of waste liquid on the inner peripheral surface of the drum like waste liquid tank 6, the diameter of the inner space is gradually reduced. When the reduced degree is advanced to a predetermined level, the drum like waste liquid tank 6 is exchanged to new one. At this time, since the irradiation means 7 and the ink discharge path 5 are disposed at the vicinity of the drum like shaft center, even when the cured waste liquid is recovered to some degree in the drum like waste liquid tank 6 and the diameter of the inner space is reduced, the recovering operation is not prevented, and the recovering amount of the cured waste liquid can be maximized.

As described above, in the waste liquid treating device 10 of the embodiment, since energy ray for curing waste liquid is irradiated in the drum like waste liquid tank 6 that is rotated about the rotation axis 11 of the drum, the uncured waste liquid 15 stored at the bottom of the drum like waste liquid tank 6 is cured while sequentially adhering on the inner peripheral surface by the irradiation of the energy ray. In this manner, since the waste liquid 15 is cured while adhering on the inner peripheral surface of the drum like waste liquid tank 6, all of the uncured waste liquid 15 stored at the bottom of the drum like waste liquid tank 6 is adhered on the inner peripheral surface of the drum like waste liquid tank 6 and cured before long by continuing rotation of the drum like waste liquid tank 6 and irradiation of energy ray for curing in the drum like waste liquid tank 6. By repeating the operations, all of the waste liquid 15 in the drum like waste liquid tank 6 is cured and there remains no uncured portion. Accordingly, safeness and comfort of operations in the recovering/treating of the drum like waste liquid tank 6 can be assured.

Further, the irradiation means 7 is constituted so as to irradiate the inner peripheral surface of the drum like waste liquid tank 6 that is wetted by the introduced waste liquid 15 when the drum like waste liquid tank 6 is rotated. Accordingly, by the rotation of the drum like waste liquid tank 6 and the irradiation of energy ray, the liquid film 16 wetted in a thin film state on the inner peripheral surface of the drum like waste liquid tank 6 is effectively cured while adhering on the inner peripheral surface. Accordingly, the introduced waste liquid 15 can be cured for a short period, and all of the waste liquid 15 in the drum like waste liquid tank 6 can be cured and there remains no uncured portion. Accordingly, safeness and comfort of operations in the recovering/treating of the drum like waste liquid tank 6 can be assured.

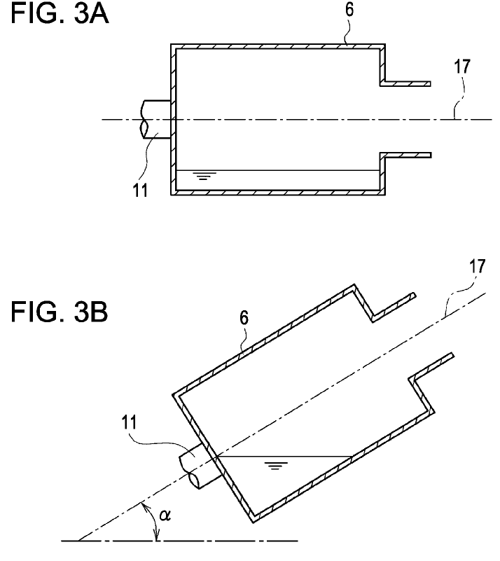

FIGS. 3A and 3B are diagrams illustrating a modification of the waste liquid treating device 10 of the invention.

FIG. 3A shows a case in which a shaft center 17 of the drum like waste liquid tank 6 is set to approximately level similarly to the first embodiment. On the contrary, in FIG. 3B, the shaft center 17 of the drum like waste liquid tank 6 is set to incline with respect to level by a predetermined inclined angle α. It is preferable that the inclined angle α is 0 to 60 degrees. That is, it is preferable that the angle of the rotation axis 11 of the drum like waste liquid tank 6 is set to level or level to 60 degrees.

If the inclined angle α is about 0 degree, when the waste liquid 15 is introduced in the drum like waste liquid tank 6, the uncured waste liquid 15 stored at the bottom is spread, and the waste liquid 15 is effectively cured while adhering on the inner peripheral surface by the rotation of the drum like waste liquid tank 6 and the irradiation of energy ray. Consequently, all of the waste liquid 15 in the drum like waste liquid tank 6 is cured and there remains no uncured portion. Accordingly, safeness and comfort of operations in the recovering/treating of the drum like waste liquid tank 6 can be assured. On the other hand, when the inclined angle α becomes about 60 degrees, the correction amount of the waste liquid in the drum like waste liquid tank 6 can be increased.

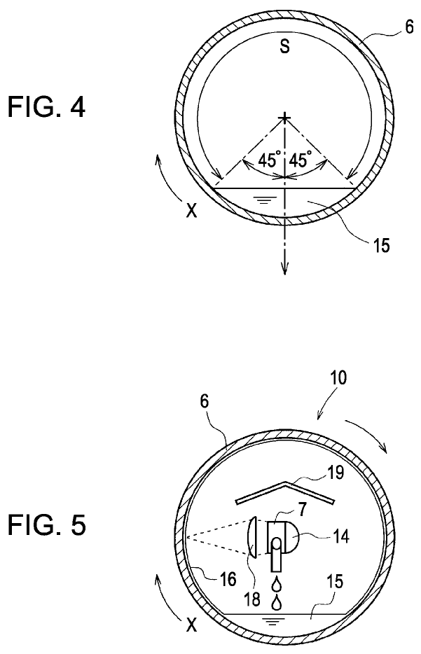

FIG. 4 is a diagram illustrating a modification of the waste liquid treating device 10 of the invention.

In the first embodiment, the sighting angle of the irradiation means 7 is within about 90 degrees on the inner peripheral surface at the downstream side of the rotating direction (shown by arrow X in FIG. 4) than the waste liquid 15 stored at the bottom of the drum like waste liquid tank 6. However, the invention is not limited to this as far as the irradiation means 7 irradiates the inner peripheral surface of the drum like waste liquid tank 6 that is wetted due to stored waste liquid 15 adhered in a film manner when the drum like waste liquid tank 6 is rotated.

That is, what is essential is that the irradiation means 7 irradiates a wall surface (area shown by S of FIG. 4) above the border line between the liquid surface of the waste liquid 15 stored at the bottom of the drum like waste liquid tank 6 and the inner peripheral surface of the drum like waste liquid tank 6. Preferably, the irradiation means 7 shall irradiate a wall surface above the border line between the liquid surface of the waste liquid 15 stored at the bottom of the drum like waste liquid tank 6 in the case where the waste liquid 15 is stored to the maximum and the inner peripheral surface of the drum like waste liquid tank 6. Further, for example, the irradiation means 7 may irradiate a wall surface above the area formed within back and forth inclined 45 degrees from the vertical line that passes through the shaft center.

FIG. 5 is a diagram showing a waste liquid treating device 10 according to a second embodiment of the invention.

In the example, a lens 18 as focus means for focusing irradiated energy ray is disposed in front of an irradiating portion of the irradiation means 7. Herewith, lighting intensity of the energy ray emitted on the liquid film 16 of the waste liquid 15 adhered on the inner peripheral surface of the drum like waste liquid tank 6 is increased, and curing efficiency is improved. Further, in the embodiment, a cover member 19 is provided above the irradiation means 7 and the lens 18. Herewith, it can be prevented that a liquid drop of the waste liquid 15 that is dropped from the inner peripheral surface that passes the upper portion is adhered on the irradiation means 7 and the lens 18. Other elements are the same as those of the aforementioned embodiment, and the same reference numerals are used for the same elements. Also in the embodiment, the similar effect as that of the aforementioned embodiment can be provided.

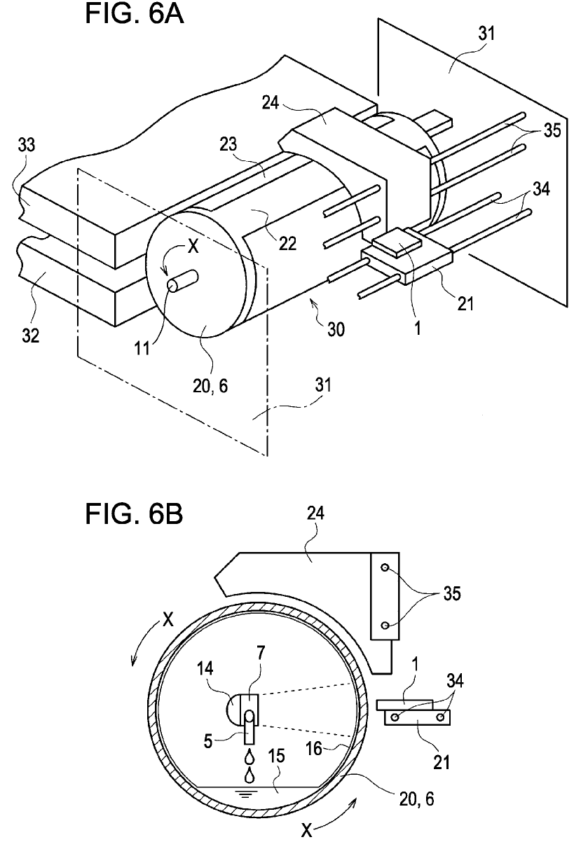

FIG. 6 is a diagram showing a waste liquid treating device 10 according to a third embodiment of the invention.

In the embodiment, the ink jet type recording apparatus is equipped with a support drum 20 that supports a recording paper 23 which is a recording medium on a support surface 22 and that rotates, an ejection head 1 that is mounted on a carriage 21 that is reciprocated in the direction perpendicular to the rotating direction of the support drum 20 along the support surface 22 and that ejects energy ray curing type liquid from a nozzle toward the recording paper 23 supported on the support surface 22, and an irradiation section 24 for irradiating energy ray with respect to the energy ray curing type liquid ejected from the ejection head 1 and adhered on the recording paper 23. The support drum 20 also serves as the drum like waste liquid tank 6.

To be more specific, in the ink jet type recording apparatus, a recording unit 30 is provided between a pair of frames 31 that are opposed to each other and that stand erect, and the recording paper 23 is supplied from a supply unit 32 to a recording unit 32, and the recording paper 23 on which recording is performed is discharged to a discharge unit 33.

The recording unit 30 is constituted to include the support drum 20 supported between the pair of frames 31 that are parallel to each other, a pair of first guide axes 34 and a pair of second guide axes 35, the carriage 21 that is guided by the first guide axes 34 and is reciprocated along the support drum 20, the ejection head 1 mounted on the carriage 21, and the irradiation section 24 that is supported by the second guide axes 35 and is reciprocated along the support drum 20.

The ejection head 1 mounted on the carriage 21 ejects ultraviolet curing type ink to the recording paper 23 that is supported and rotated by the support drum 23 for adhesion. Further, ultraviolet is irradiated from the irradiation section 24 to the ultraviolet type curing type ink adhered on the recording paper 23. In this manner, an image formed by the ultraviolet curing type ink is fixed on a surface of the recoding paper 23.

Further, when the support drum 20 is rotated by not less than one rotation and an image is recorded on a part area of the recording paper 23 in the longitudinal direction of the support drum 20, the carriage 21 is moved along the first guide axes 34, and the similar recording operation is performed in an area adjacent to the part area. Then, an image is formed on the entire surface of the recording paper 23 by repeating the operation for moving the carriage 21 for every not less than one rotation of the support drum 20 while recording by the ejection head 1.

The support drum 20 also serves as the drum like waste liquid tank 6. Waste liquid is introduced in the support drum 20 that is rotated, and energy ray is irradiated to the liquid film 16 adhered on the inner peripheral surface by the irradiation means 7 disposed in the support drum 20 for curing.

In the embodiment, the support drum 20 also serves as the drum like waste liquid tank 6 in a liquid ejecting apparatus of a type that supports the recording paper 23 on the support drum 20 and ejects energy ray curing type ink. Herewith, the space for storing waste liquid can be substantially reduced, and this is advantageous for downsizing the apparatus.

Note that in the embodiments, the LED that emits light in the ultraviolet band is exemplified as the irradiation means 7. However, this is not limited. For example, a metal halide lamp, a xenon lamp, a carbon arc lamp, a chemical lamp, a low pressure mercury lamp, a high pressure mercury lamp, various energy ray irradiation means, can be applied as the irradiation means 7.

In the embodiments, the ejection head 1 may be applied to a liquid ejecting apparatus using a piezoelectric oscillator as a pressure generating element that is a driving element for ejecting liquid, and may be applied to a liquid ejecting apparatus of a type using a heater element.

As a typical example of the liquid ejecting apparatus, there is the ink jet type recording apparatus equipped with an ink jet type recording head for recording an image as described above. The invention can be also applied to various liquid ejecting apparatuses as other liquid ejecting apparatus, for example, such as a device equipped with a color material ejection head used for manufacturing a color filter for a liquid crystal display or the like, a device equipped with an electrode material (conductive paste) ejection head used for forming an electrode for an organic EL display, a field emission display (FED), or the like, a device equipped with a bio organic material ejection head used for manufacturing a bio chip, a device equipped with a sample ejection head as a precision pipette, and the like.

What is claimed is:

1. A waste liquid treating device comprising:
a drum like waste liquid tank that can be rotated in which liquid that is cured by irradiation of energy ray is introduced as waste liquid;
a rotation driving unit for rotating the drum like waste liquid tank about a rotation axis of the drum like waste liquid tank; and
an irradiation unit for irradiating energy ray for curing waste liquid in the drum like waste liquid tank that is rotated by the rotation driving unit.

2. The waste liquid treating device according to claim 1, wherein an angle of a shaft center of the drum like waste liquid tank is set to level or level to 60 degrees.

3. The waste liquid treating device according to claim 1, wherein the irradiation unit is constituted to irradiate an inner peripheral surface of the drum like waste liquid tank that is wetted due to stored waste liquid adhered in a film manner when the drum like waste liquid tank is rotated.

4. The waste liquid treating device according to claim 1 further comprising:
a support drum that is rotated for supporting a recording medium on a support surface;
an ejection head for ejecting energy ray curing type liquid from a nozzle toward the recording medium supported on the support surface; and
an irradiation section for irradiating energy ray with respect to the energy ray curing type liquid ejected from the ejection head and adhered on the recording medium, wherein
the support drum also serves as the drum like waste liquid tank.
